(19) United States
(12) Patent Application Publication
(10) Pub. No.: US 2026/0233133 A1
(43) Pub. Date: Aug. 13, 2026

(54) SEWAGE SOLIDS-LIQUIDS SEPARATOR SYSTEM AND METHOD

(71) Applicant: WWJD, Inc., Bentonville, AR (US)

(72) Inventor: Jon D. Jouvenaux, Bentonville, AR (US)

(73) Assignee: WWJD, Inc., Bentonville, AR (US)

(21) Appl. No.: 19/462,110

(22) Filed: Jan. 28, 2026

Related U.S. Application Data
(60) Provisional application No. 63/756,975, filed on Feb. 11, 2025.

(51) Int. Cl. B01D 33/03; B01D 33/056

(52) U.S. Cl. CPC B01D 33/0353; B01D 33/056

(57) ABSTRACT

Solids-liquid separation systems are disclosed that include a tank, a basket assembly, a feedbox, and an auger assembly. The tank has a front end, a rear end, a top side, a bottom side, a length and a width. The basket assembly is mounted to the top side of the tank and extends over at least a portion of the length of the tank. The feedbox is mounted to the rear end of the tank. The auger assembly mounted to the front end of the tank.

### CROSS-REFERENCE TO RELATED APPLICATIONS

This application claims priority to U.S. Provisional Application No. 63/756,975, filed on Feb. 11, 2025 and titled: SEWAGE SOLIDS-LIQUIDS SEPARATOR SYSTEM AND METHOD.

### TECHNICAL FIELD

The present technology relates to solids-liquids separators, and particularly to solids-liquids separators for separating solids and liquids from sewage.

### BACKGROUND

Sewage is a type of wastewater that generally includes a slurry of solids and liquids that may contain human waste, toilet paper, and other trash, and that may be discharged from residences and from commercial, institutional and public facilities. In some applications, sewage is gathered and transported for treatment by liquid waste hauler trucks and trailers. In various applications, trash and other solids must be separated out of a liquid stream as a primary step for proper treatment and disposal of both.

### BRIEF DESCRIPTION OF THE DRAWINGS

Specific examples have been chosen for purposes of illustration and description, and are shown in the accompanying drawings, forming a part of the specification.

FIG. 1 is a front perspective view of a solids-liquid separation system of the present technology.

FIG. 2 is a front elevational view of the solids-liquid separation system of FIG. 1.

FIG. 3 is a rear perspective view of the solids-liquid separation system of FIG. 1.

FIG. 4 is a left side elevational view of the solids-liquid separation system of FIG. 1.

FIG. 5 is a right side elevational view of the solids-liquid separation system of FIG. 1.

FIG. 6 is a top plan view of the solids-liquid separation system of FIG. 1.

FIG. 7 is a front perspective view of a feedbox of the solids-liquid separation system of FIG. 1.

While various embodiments discussed herein are amenable to modifications and alternative forms, aspects thereof have been shown by way of example in the drawings and are described in detail herein. It should be understood, however, that the disclosure is not limited to the particular embodiments described, and instead is meant to include all modifications, equivalents, and alternatives falling within the scope of the disclosure. In addition, the terms “example” and “embodiment” as used throughout this application is only by way of illustration, and not limitation. The term “about” with respect to a measurement as used herein means the stated measurement plus or minus a 10% margin of error. The term “configured to” as used herein with respect to a component being “configured to” have certain structural characteristics in specified circumstances or to perform a function means that the component is structurally formed such that the component meets the structural characteristics in the specified circumstances or performs the function without further modification. The Figures are not necessarily drawn to scale. The use of the same reference symbols in different drawings indicates similar or identical items unless otherwise noted.

### DETAILED DESCRIPTION

The present technology includes solids-liquid separation systems, and more particularly solids-liquids separators for separating solids and liquids from sewage.

Solids-liquid separation systems of the present technology may be particularly useful in applications involving the unloading of liquid waste hauler trucks and trailers. However, it should be understood that solids-liquid separation systems of the present technology may also be used in other situations where separating solids and trash out of a liquid stream is needed. Solids-liquid separation systems of the present technology may provide improvements over pre-existing solids-liquid separation systems with respect to screening debris out of the liquid, such as increased speed and higher quality separation, which may allow more productive time to be added back to waste hauler trucks. Preferably, such technology can separate liquids from solids at a high average flow rate, such as an average flow rate of from about 300 gpm to at least about 1200 gpm, or greater, including for example an average flow rate of about 400 gpm.

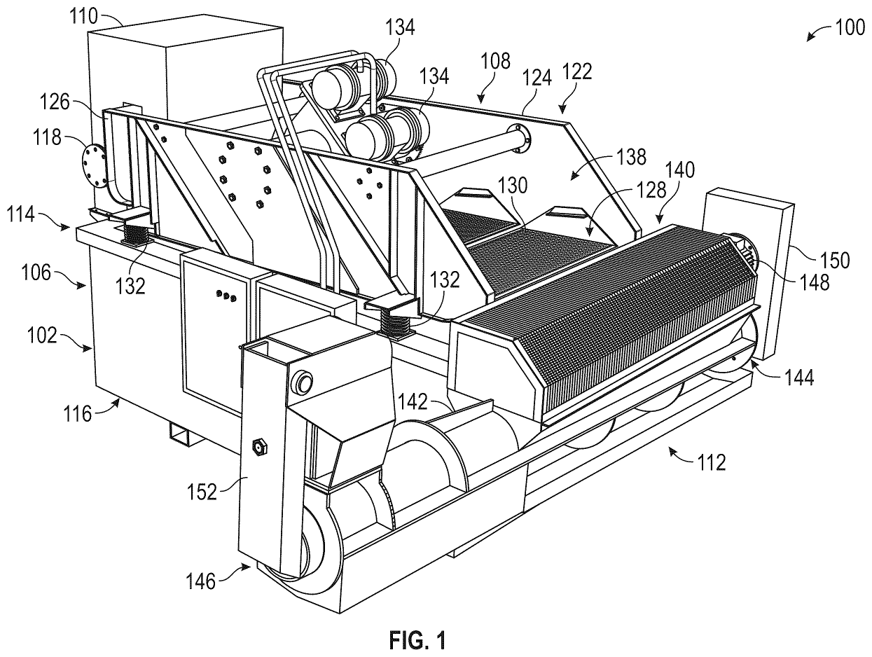

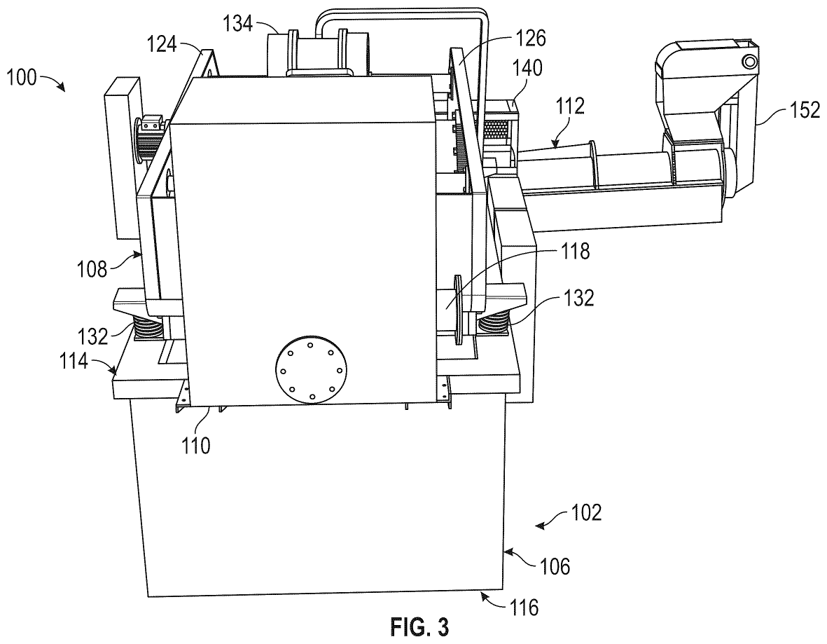

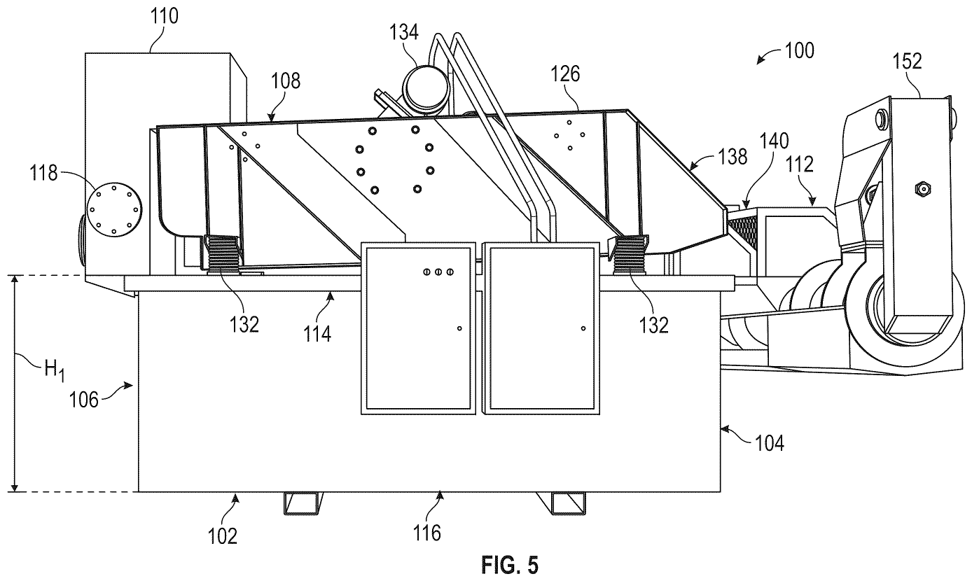

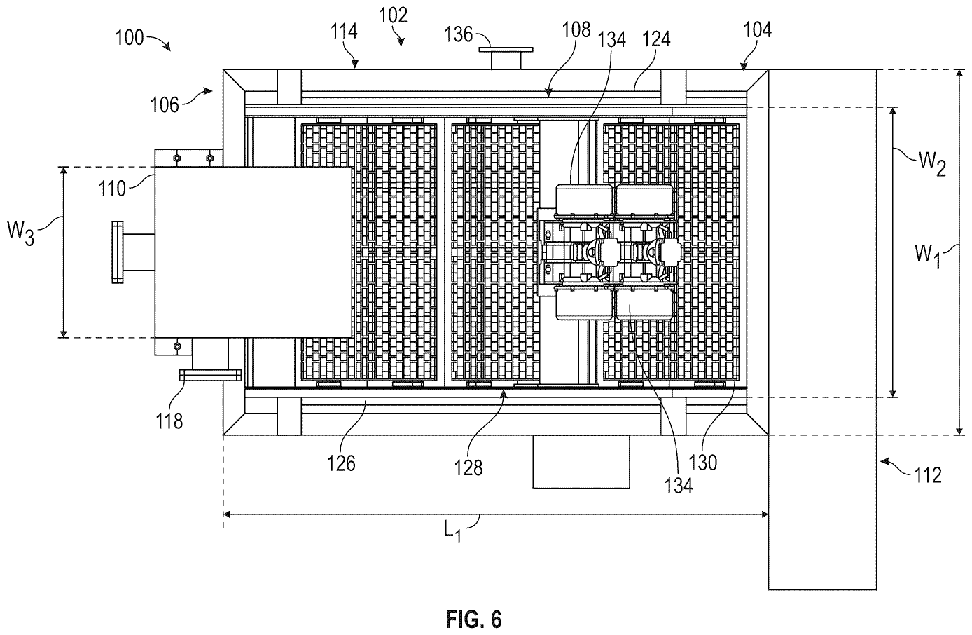

FIGS. 1-6 illustrate one example of a solids-liquid separation system 100 of the present technology. The solids-liquid separation system 100 includes a tank 102 having a front end 104 and a rear end 106 opposite the front end, as well as a top side 114 and a bottom side 116. As shown in FIG. 6, the tank has a tank length L1 and a tank width W1. The tank 102 may be any suitable shape, such as square or generally square, rectangular or generally rectangular, oblong, or any other suitable shape. The tank 102 may have squared corners or rounded corners. As best shown in FIG. 5, the tank has a tank height H1. The dimensions of the tank 102, including the tank length L1, tank width W1, and tank height HI, may be varied depending upon the application and desired operating flow rate. In at least one example, the tank 102 may have a tank length L1 ranging from about 8 feet to about 10 feet, such as being about 9 feet, or between about 9 feet and about 10 feet. In at least one example, the tank 102 may have a tank width Wi ranging from about 5 feet to about 6 feet, such as being between about 5.5 feet and about 6 feet. In at least one example, the tank 102 may have a tank height HI ranging from about 3 feet to about 5 feet, such as being between about 3.5 feet and 4.5 feet. In one example, the tank may have a tank length Li of about 109 inches, a tank width W1 of about 68 inches, and tank height H1 of about 47 inches.

Referring back to FIGS. 1-6, the solids-liquid separation system 100 also includes a basket assembly 108 mounted to the top side 114 of the tank 102 that extends over at least a portion of the length tank L1 (FIG. 6) of the tank 102, a feedbox 110 mounted to the rear end 106 of the tank 102, and an auger assembly 112 mounted to the front end 104 of the tank 102.

As best shown in FIGS. 1, 3, 5 and 6, the feedbox 110 includes a feedbox inlet 118. The feedbox inlet 118 is configured to and does receive a feed stream (not shown) that contains solids and liquids. The feedbox inlet 118 may be configured to attach to a hose, through which the fed stream may be provided. The feedbox inlet may be near the bottom of the feedbox 110, and is preferably positioned low enough to prevent solids such as grit and dirt from collecting in the bottom of the feedbox 110. The feedbox inlet 118 is preferably located on a side of the feedbox 110, as shown in FIGS. 1, 3, 5 and 6. Although only one feedbox inlet 188 is shown, it should be understood that multiple feedbox inlets 118 may be provided, such as two feedbox inlets 118 where one is provided on each side of the feedbox 110, such that the feed stream may be provided into the feedbox 110 from either side. The feed stream may be fed into the feedbox inlet 118 at a high average flow rate, such as an average flow rate of from about 300 gpm to at least about 1200 gpm, or greater, including for example an average flow rate of about 400 gpm.

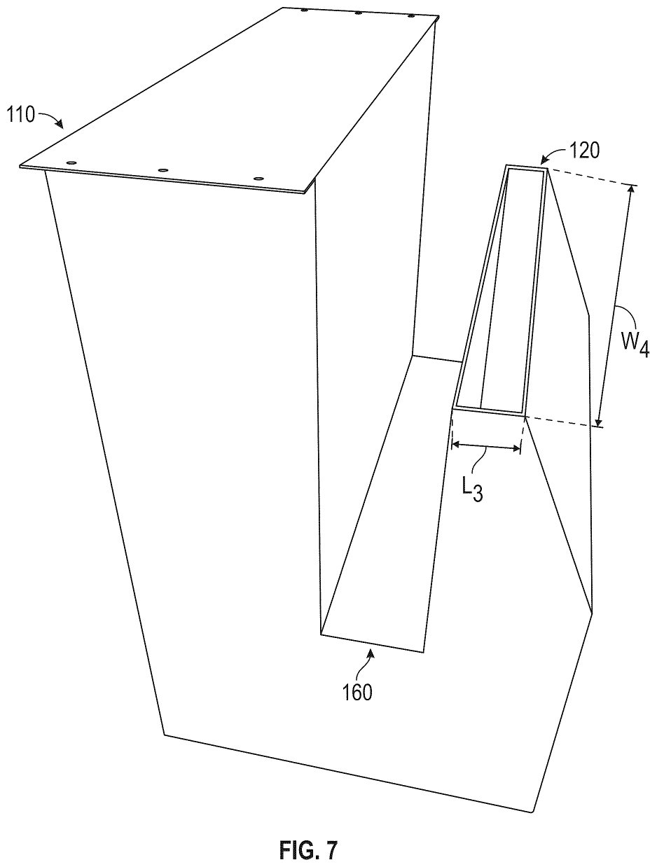

FIG. 7 illustrates an example of the feedbox 110 in isolation and inverted from the orientation in which it would be installed in the solids-liquid separation system 100. The feedbox 110 has a feedbox discharge port 120 configured to discharge the feed stream into the basket assembly 108. As shown in FIG. 6, the basket assembly 108 has a basket width W2 that is less than the tank width W1 of the tank 102, and the feedbox 110 has a feedbox width W3 that is less than the basket width W2 of the basket assembly 108. Accordingly, referring to FIGS. 6 and 7, the feedbox discharge port 120 has a discharge port width W4 (FIG. 7) that is less than the basket width W2 (FIG. 6) of the basket assembly 108. In at least one example, the basket width W2 of the basket assembly 108 is about four feet, and the discharge port width W4 is about 3 feet. The discharge port 120 may have any suitable discharge port length L3, and should be long enough so that solids can flow therethrough and not get stuck in the feedbox 110. In at least one example, the discharge port length L3 may be from about 3 inches to about 6 inches, and may be, for example about 3 inches, about 4 inches, about 5 inches, or about 6 inches. In at least one example, the inside of the feedbox is a continuous chamber from the inlet 118 to the opening 120 so the outside shape defines the inside shape. When installed, the feedbox discharge port 120 may be at a location on the feedbox 110 that is higher than the feedbox inlet 118, but lower than a top level 122 (FIG. 1) of the basket assembly 108 to ensure there is no splashing outside of the basket assembly 108.

Referring to FIGS. 1-7, during use of the solids-liquid separation system 100, the feed stream enters the feedbox 110, and collects in the feedbox 110 until the level has risen high enough for the feed stream to exit the feedbox 110 through the feedbox discharge port 120. The feedbox 110 allows for the feed stream (not shown) to enter the feedbox inlet 118 at a high flow rate, spreads the feed stream out over feedbox width W3, then directs the flow of the feed stream up and over a feedbox inner wall 160 and then down through the feedbox discharge port 120 (i.e., in an inverted U-shaped path from 118 to 120) and into the basket assembly 108. In at least some examples, the design and placement of the feedbox 110 relative to the basket assembly as described herein may allow for relief at the end of a load, when air is being pushed in to the feedbox 110, without having blow back or spray outside of the screen area.

The basket assembly 108 includes a first side 124, a second side 126, and a screening surface 128 that extends between the first side 124 and the second side 126. The first side 124 and the second side 126 define the top level 122 of the basket assembly 108. As best shown in FIGS. 1 and 6, the screening surface 128 may include a plurality of individual screens 130. Each screen 130 may be perforated, woven, or otherwise formed to have spaces, with the spaces being sized to allow liquid to fall through the screen 130 into the tank 102. The spaces defined in the screens 130 should be small enough that solids are retained on the screen 30 without falling through, but large enough to allow liquid to pass through the screen 130. In at least some examples, the spaces may be about 3/16 inches or about ¼ inches. The screening surface 128, and each of the screens 130, may be made from stainless steel, which may facilitate the longevity of a smooth surface and guard against any roughness that hair and fabric debris in the feed stream could get caught on.

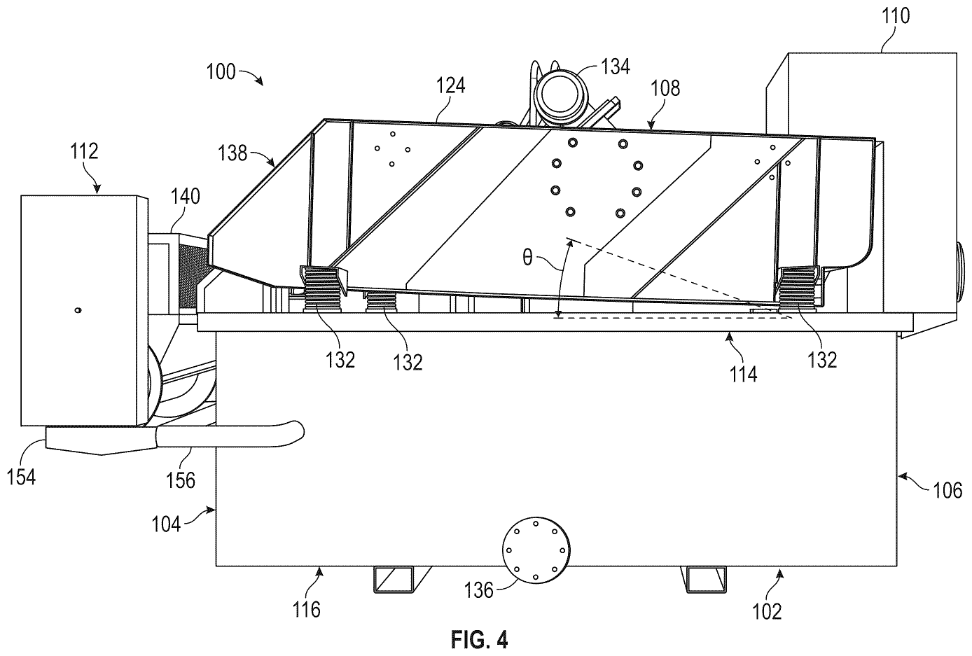

Referring to FIGS. 1, 3, 4 and 5, the basket assembly 108 may be mounted to the top side 114 of the tank 102 by a plurality of springs 132. As best shown in FIG. 4, the basket assembly 108 may be mounted at a basket mounting angle 0, such that it is slanted upwards from horizontal as it extends from rear end 106 towards the front end 104 of the tank 102.

Referring to FIGS. 1-6, the basket assembly 108 may include at least one motor 134. As shown, the basket assembly 108 includes two motors 134. Each motor 134 may include interior offset weights (not shown) that spin during use of the solids-liquid separation system 100, causing the basket assembly 108 to vibrate, and may cause the basket assembly 108 to vibrate in an orbital fashion. The solids-liquid separation system 100 is configured such that, during operation, vibration of the basket assembly 108 causes solids in the feed stream to travel along the screening surface 128 towards the front end 104 of the tank 102, while liquid from the feed stream will fall through the screening surface 128 into the tank 102.

The tank 102 is configured to receive and retain liquids that pass through the screening surface 128. As best shown in FIGS. 4 and 6, the tank 102 includes a tank outlet valve 136. Liquid from the feed stream that passes through the screening surface 128 into the tank 102 may be drained from the tank 102 through the tank outlet valve 136. Such liquid may then be removed to another location for further processing. The tank 102 may be sized to accommodate any desired flow rate, or average flow rate, such as an average flow rate of from about 300 gpm to at least about 1200 gpm, or greater, including for example an average flow rate of about 400 gpm, and also including a buffer to ensure that the liquid from the feed stream does not overflow the tank 102.

As best shown in FIGS. 1, 4 and 5, the basket assembly 108 includes a basket outlet 138. Solids in the feed stream that travel along the screening surface 128 towards the front of the tank 102 during operation of the solids-liquid separation system 100 may exit the basket assembly 108 through the basket outlet 138 and enter into the auger assembly 112.

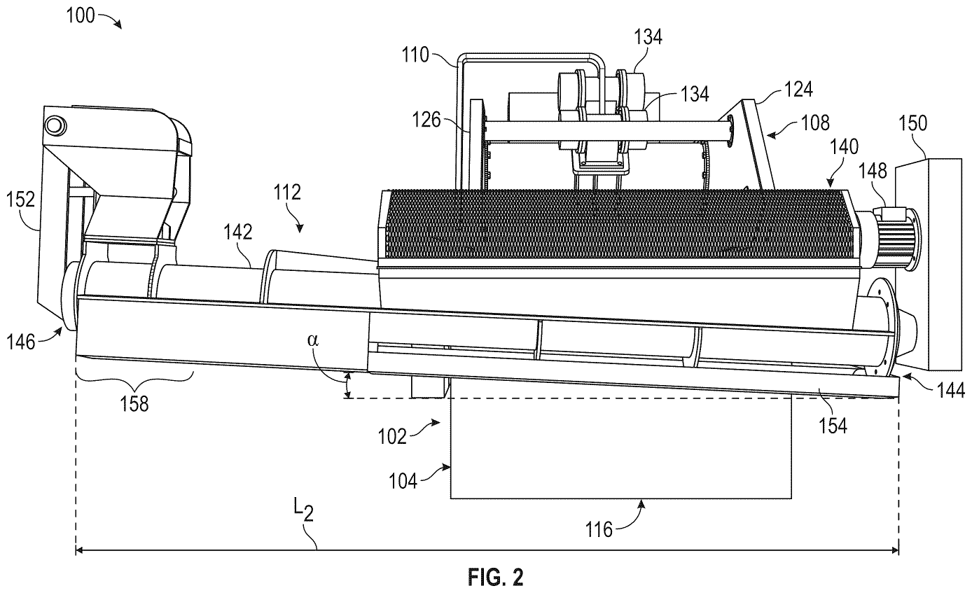

As best shown in FIGS. 1-5, the auger assembly 112 includes a hopper 140. The hopper 140 is located and configured to receive solids that exit out of the basket outlet 138. The hopper 140 may be covered by a hinged safety cover, which may have safety switches that will not allow the auger to spin if the safety cover is open. Referring to FIGS. 1 and 2, the auger assembly 112 includes an auger housing 142 that has a first end 144 and a second end 146 opposite the first end 144. The auger assembly 112 incudes a motor 148 and a gear box 150 mounted at the first end 144 of the auger housing 142, and a cap 152 at the second end 146 of the auger housing 142. The auger assembly 112 includes an auger (not shown) that is connected to and driven by the motor 148 and gear box 150, and that extends within the auger housing 142 from the first end 144 towards the second end 146 along a portion of the housing length L2 (FIG. 2) of the auger housing 142. Accordingly the motor 148 and gear box 150 are mounted at the downhill side of the auger assembly 112 and the a cap 152 is mounted at the uphill side of the auger assembly 112.

Referring to FIG. 2, the auger assembly 112 may be mounted at an auger assembly mounting angle a, such that the auger assembly 112 is slanted upwards from horizontal as it extends from the first end 144 to the second end 146. Additionally, the auger assembly 112 may include a travel surface (not shown), which may be a screened surface, and a drain pan 154 underneath the travel surface to allow liquids to fall away from the solids into the drain pan 154. Referring to FIG. 4, the drain pan 154 includes a drain pan discharge port 156 that empties into the tank 102.

Referring back to FIG. 2, during use of the solids-liquid separation system 100, the auger runs and transports solids uphill to the second end 146 of the auger housing 142. The auger may taper off near the second end 146 of the auger housing 142, leaving a gathering section 158 of the auger housing 142 empty for gathering the solids. The cap 152 which covers the end of the tube may be spring loaded, and thus be able to withstand a certain amount of pressure exerted against the cap 152 by solids gathering in the gathering section 158, up to a threshold pressure that causes the cap 152 to open. As the auger transports the solids, they gather in the gathering section 158 and build up as the auger continues to move more solids, which causes the gathering solids to exert pressure on each other and may squeeze out excess liquid, thus assisting in drying out the solids. Once the gathered solids build up enough pressure to cause the cap 152 to open, the solids may drop into a receptacle (not shown), and may then be transported for disposal.

Using the solids-liquid separation system 100, particularly the auger assembly 112 as described above, may result in increased or improved drying of solid materials as compared to conventional solids-liquid separation systems, which may reduce the weight of the solids and may in turn reduce the amount of solid waste material dump fees incurred for disposal of the solids. Additionally, using the solids-liquid separation system 100, particularly the auger assembly 112 as described above, may result in the solids being dried out sufficiently to pass the “Paint Filter” test used by landfills as a standard way of gauging what is allowed to enter the landfills to reduce the amount of contaminated water runoff.

In accordance with the discussion above, it should be understood that the present technology includes various embodiments of solids-liquid separation systems. In at least one embodiment, a solids-liquid separation system of the present technology includes: a tank having a front end, a rear end, a top side, a bottom side, a length and a width; a basket assembly mounted to the top side of the tank that extends over at least a portion of the length L of the tank; a feedbox mounted to the rear end of the tank; and an auger assembly mounted to the front end of the tank.

Such solids-liquid separation systems of the present technology may include one or more additional features. For example, the solids-liquid separation system may include a feedbox inlet and a feedbox discharge port, the feedbox discharge port being at a location on the feedbox that is higher than the feedbox inlet and lower than a top level of the basket assembly. Additionally or alternatively, the basket assembly may have one or more specific features. The basket width may be less than the tank width of the tank, and the feedbox has a feedbox width that is less than the basket width of the basket assembly. The basket assembly may include a first side, a second side, and a screening surface that extends between the first side and the second side. The basket assembly may be mounted such that the basket assembly is slanted upwards from horizontal as it extends from the rear end of the tank to the front end of the tank. The basket assembly may vibrate during operation to move solids upward and forward from the rear end of the tank to the front end of the tank. Further, the basket assembly may include at least one motor that causes the basket assembly to vibrate during operation. Additionally or alternatively, the auger assembly may have one or more specific features. The auger assembly may include: an auger housing that has a first end and a second end opposite the first end; a motor and a gear box mounted at the first end of the auger housing; and a cap at the second end of the auger housing. The auger assembly may be mounted at an auger assembly mounting angle such that the auger assembly is slanted upwards from horizontal as it extends from the first end to the second end. The auger assembly may further include a drain pan having a drain pan discharge port that empties into the tank. The cap of the auger assembly may be spring loaded such that a threshold pressure is required to cause the cap to open.

From the foregoing, it will be appreciated that although specific examples have been described herein for purposes of illustration, various modifications may be made without deviating from the spirit or scope of this disclosure. It is therefore intended that the foregoing detailed description be regarded as illustrative rather than limiting, and that it be understood that it is the following claims, including all equivalents, that are intended to particularly point out and distinctly claim the claimed subject matter.

What is claimed is:

1. A solids-liquid separation system comprising:
a tank having a front end, a rear end, a top side, a bottom side, a length and a width;
a basket assembly mounted to the top side of the tank that extends over at least a portion of the length L of the tank;
a feedbox mounted to the rear end of the tank; and
an auger assembly mounted to the front end of the tank.

2. The solids-liquid separation system of claim 1, further comprising a feedbox inlet and a feedbox discharge port, the feedbox discharge port being at a location on the feedbox that is higher than the feedbox inlet and lower than a top level of the basket assembly.

3. The solids-liquid separation system of claim 1, wherein the basket assembly has a basket width that is less than the tank width of the tank, and the feedbox has a feedbox width that is less than the basket width of the basket assembly.

4. The solids-liquid separation system of claim 1, wherein the basket assembly includes a first side, a second side, and a screening surface that extends between the first side and the second side.

5. The solids-liquid separation system of claim 1, wherein the basket assembly is mounted such that the basket assembly is slanted upwards from horizontal as it extends from the rear end of the tank to the front end of the tank.

6. The solids-liquid separation system of claim 5, wherein the basket assembly vibrates during operation to move solids upward and forward from the rear end of the tank to the front end of the tank.

7. The solids-liquid separation system of claim 1, wherein the basket assembly includes at least one motor that causes the basket assembly to vibrate during operation.

8. The solids-liquid separation system of claim 1, wherein the auger assembly includes:
an auger housing that has a first end and a second end opposite the first end;
a motor and a gear box mounted at the first end of the auger housing; and
a cap at the second end of the auger housing.

9. The solids-liquid separation system of claim 8, wherein the auger assembly is mounted at an auger assembly mounting angle such that the auger assembly is slanted upwards from horizontal as it extends from the first end to the second end.

10. The solids-liquid separation system of claim 8, wherein the auger assembly further includes a drain pan having a drain pan discharge port that empties into the tank.

11. The solids-liquid separation system of claim 8, wherein the cap is spring loaded such that a threshold pressure is required to cause the cap to open.

12. A solids-liquid separation system comprising:
a tank having a front end, a rear end, a top side, a bottom side, a length and a width;
a basket assembly mounted to the top side of the tank that extends over at least a portion of the length L of the tank;
a feedbox mounted to the rear end of the tank; and
an auger assembly mounted to the front end of the tank, the auger assembly including an auger housing that has a first end and a second end opposite the first end, wherein the auger assembly is mounted at an auger assembly mounting angle such that the auger assembly is slanted upwards from horizontal as it extends from the first end to the second end.

13. The solids-liquid separation system of claim 12, further comprising a feedbox inlet and a feedbox discharge port, the feedbox discharge port being at a location on the feedbox that is higher than the feedbox inlet and lower than a top level of the basket assembly.

14. The solids-liquid separation system of claim 12, wherein the basket assembly has a basket width that is less than the tank width of the tank, and the feedbox has a feedbox width that is less than the basket width of the basket assembly.

15. The solids-liquid separation system of claim 12, wherein the basket assembly includes a first side, a second side, and a screening surface that extends between the first side and the second side.

16. The solids-liquid separation system of claim 12, wherein the basket assembly is mounted such that the basket assembly is slanted upwards from horizontal as it extends from the rear end of the tank to the front end of the tank.

17. The solids-liquid separation system of claim 16, wherein the basket assembly vibrates during operation to move solids upward and forward from the rear end of the tank to the front end of the tank.

18. The solids-liquid separation system of claim 12, wherein the basket assembly includes at least one motor that causes the basket assembly to vibrate during operation.

19. The solids-liquid separation system of claim 12, wherein the auger assembly further includes:
a motor and a gear box mounted at the first end of the auger housing; and
a cap at the second end of the auger housing, wherein the cap is spring loaded such that a threshold pressure is required to cause the cap to open.

20. The solids-liquid separation system of claim 12, wherein the auger assembly further includes a drain pan having a drain pan discharge port that empties into the tank.
